(19) United States
(12) Patent Application Publication
(10) Pub. No.: US 2018/0254950 A1
(43) Pub. Date: Sep. 6, 2018

(54) Installation Devices for Connecting Pool or Spa Devices to a Local Area Network

(71) Applicant: Pentair Water Pool and Spa, Inc., Cary, NC (US)

(72) Inventors: Rakesh Reddy, Deerfield Beach, FL (US); Kevin Doyle, Deerfield Beach, FL (US); Robert J. Netzel, SR., Simi Valley, CA (US)

(21) Appl. No.: 15/969,552

(22) Filed: May 2, 2018

Related U.S. Application Data
(62) Division of application No. 15/165,991, filed on May 26, 2016.

(51) Int. Cl. H04L 12/24; H04W 24/02; H04W 48/08; H04W 4/80; H04L 29/08; H04W 84/12

(52) U.S. Cl. CPC H04L 41/0816; H04W 24/02; H04W 48/08; H04W 84/12; H04L 67/12; H04L 67/06; H04W 4/80

(57) ABSTRACT

An installation device for connecting a pool or spa device to a local area network comprises at least one memory device configured to store a web browser application, at least one processor configured to execute the web browser application, a server configured to generate a configuration web page through execution of the web browser application, and at least one input interface configured to receive user inputs including configuration information. The installation device is configured to connect to a host device and to display the configuration web page based on the host device detecting a connection between the installation device and the wireless access point or wireless router through the host device. The web browser application is operable to receive the configuration information through the web page and the installation device is configured to send the configuration information to the wireless access point or wireless router through the host device.

### RELATED APPLICATIONS

This application is a divisional of U.S. patent application Ser. No. 15/165,991 filed on May 26, 2016, the entire contents of which is incorporated herein by reference.

### BACKGROUND

Pools and spas often include a number of pool or spa devices that can be operated to provide various features and functions to the pool or spa. Examples of such pool or spa devices are ancillary accessories, such as lights, sound systems, waterfalls, other deck-based and non-deck-based water flow devices, devices for controlling mechanical water treatment systems, underwater projection units and other specialty lighting devices. In traditional pool or spa installations, various pool or spa accessories are not connected over a data network or otherwise communicatively interconnected. Therefore, separate control elements, devices or interfaces are typically provided for each of the accessories.

It is desirable to provide network-enabled accessories for pools or spas that can be easily configured for connection to a network. More specifically, it is desirable to provide or utilize installation devices (e.g., smart phones, tablets, computers, etc.) for connecting network-enabled pool or spa accessories to a local area network (LAN).

### SUMMARY

The disclosure is related to installation devices for connecting network-enabled devices such as pool accessories, spa accessories, other associated accessories, and/or servers configured to control the pool or spa and/or the associated accessories, to a local area network (LAN). The disclosure further relates to methods of connecting such network-enabled devices to a LAN.

An aspect of the invention is to provide a tool and method to aid an installer in installation of a network-enabled pool device or accessory with a network, for example, a local area network (LAN) or home area network (HAN) during installation at a pool, spa, fountain, water feature or similar body.

In various aspects, the invention includes, but is not limited to, an article of manufacture, a computing apparatus carrying out the method of the invention, a method, a method of executing the invention on a computer system, and a method for using an article having the invention.

According to one aspect, an installation device for connecting a pool device or spa device (e.g., client devices) may include at least one memory device configured to store a configuration file. The installation device configures a wireless access point or wireless router to enable the host device to connect to the local area network. The installation device is configured to send the configuration file to the wireless access point or wireless router through the host device. The configuration file includes data to configure the wireless access point or wireless router in order to enable a pool device or spa device to connect to the local area network.

According to another aspect, an installation device for connecting a pool device or spa device to a local area network comprises at least one memory device configured to store a web browser application and at least one processor configured to execute the web browser application. The installation device further includes a display configured to display a web page generated through execution of the web browser application and at least one input interface configured to receive user inputs including configuration information. The installation device is adapted to be configured to a default network setup service set identifier (SSID) and password of a wireless access point or wireless router. The web browser application is operable to receive the configuration information through the web page. The installation device is configured to send the configuration information to the wireless access point or wireless router in order to configure the wireless access point or wireless router to enable a pool device or spa device to connect to the local area network.

According to another aspect, an installation device for connecting a pool device or spa device to a local area network comprises at least one memory device configured to store a web browser application and at least one processor configured to execute the web browser application. The installation device further includes a server configured to generate a configuration web page through execution of the web browser application and at least one input interface configured to receive user inputs including configuration information. The installation device is configured to connect to a host device that is connected to a wireless access point or wireless router in the local area network and the installation device is further configured to display the configuration web page based on the host device detecting a connection established between the installation device and the wireless access point or wireless router through the host device. The web browser application is operable to receive the configuration information through the web page. The installation device is configured to send the configuration information to the wireless access point or wireless router through the host device in order to configure the wireless access point or wireless router to enable a pool device or spa device to connect to the local area network.

According to another aspect, the installation device is in the form of a flash memory drive, a smart phone, a tablet computer, or a computer.

According to another aspect, the pool or spa device is a light, a sound system, a speaker device, a deck-based water flow device, a non-deck-based water flow device, a water treatment system devices, a valve, a valve actuator, or an underwater projection device.

According to another aspect, the host device includes one or more processors, one or more computer device, one or more memory devices, firmware, or software.

According to another aspect, the installation device and the host device are wirelessly connected by Bluetooth or wi-fi.

According to another aspect, the installation device is configured to push the configuration file to the wireless access point or wireless router.

The above objects and advantages of the invention are illustrative, and not exhaustive, of those which can be achieved by the invention. Thus, these and other objects and advantages of the invention will be apparent from the description herein, both as embodied herein and as modified in view of any variations which will be apparent to those skilled in the art.

### DESCRIPTION OF THE DRAWINGS

FIG. 1 is a schematic diagram showing an installation device interfaced with a client/host device in a local area network (LAN) to connect a network-enabled pool or spa device to the LAN, according to an embodiment of the invention.

FIG. 2 is a schematic diagram showing an installation device interfaced with a wireless access point or wireless router in a LAN to connect a network-enabled pool or spa device to the LAN, according to another embodiment of the invention.

FIG. 3 is a schematic diagram showing an installation device interfaced with a client/host device in a LAN to connect a network-enabled pool or spa device to the LAN, according to yet another embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

The embodiments described below pertain to installation devices for connecting network-enabled pool devices or spa devices to local area networks (LANs), and methods of connecting network-enabled pool and spa devices to LANs using such installation devices. The description discloses embodiments of installation devices, LANs, pool devices or spa devices, and associated methods. It should be understood that the disclosed embodiments are merely exemplary embodiments, and additional variations and embodiments are possible.

The embodiments of the present disclosure include numerous advantages over the prior art. For example, one advantage is the networking of one or more pool and/or spa devices for ease in operating the one or more pool and/or spa devices. Networking of one or more pool and/or spa devices may reduce the number of control elements, device, or interfaces necessary for operating the one or more pool and/or spa devices. Thus, the embodiments of the present disclosure are capable of providing an improved system in which multiple pool and/or spa devices of one or more pools, spas, or other water features may be operated from a single point of access.

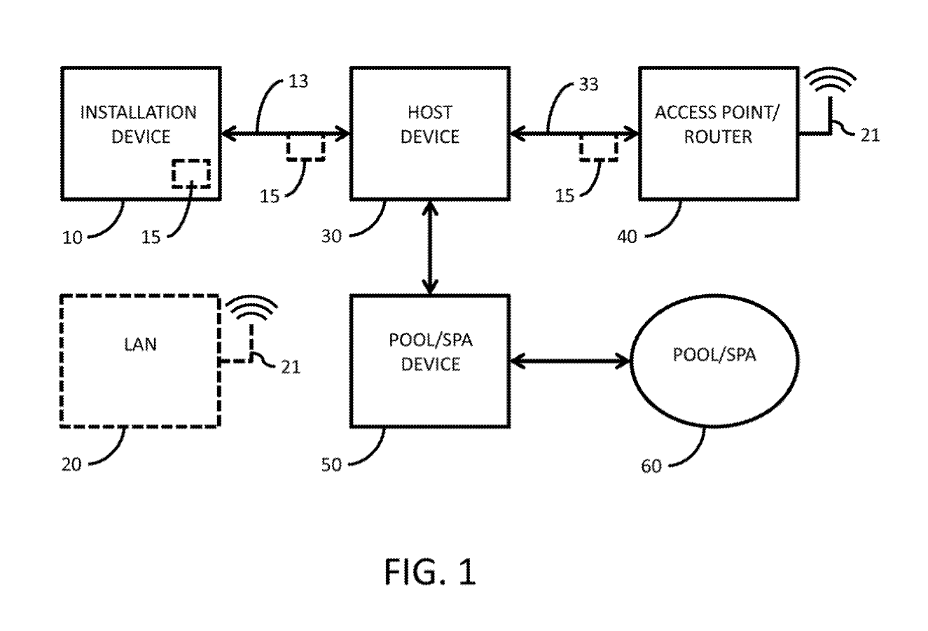

FIG. 1 shows an installation device 10 interfaced with a LAN 20 for connecting a network-enabled pool or spa device 50 to the LAN 20 and/or the Internet, according to an exemplary embodiment of the invention. Although reference is made to a pool or spa device 50, it should be noted that the pool or spa environment can include traditional pools, spas, and the like as well as fountains, displays, and similar water features which typically use lighting, other accessories, and/or devices similar to those in pools and spas. The LAN 20 can include a host device 30 connected to a wireless access point or wireless router 40.

The installation device 10 can be, for example but certainly not limited to, a handheld device, a smartphone, a tablet computer, a computer, or a flash memory drive, for example. The installation device 10 can include one or more processors, one or more memory devices, one or more input interfaces (e.g., keyboard or touchscreen), and/or any combination thereof operable to store, execute and/or output a configuration file 15. The installation device 10 can also include a display configured to display information related to the configuration file 15 and/or the installation process. The installation device 10 may be configured to modify the wireless access point 40 to communicate with the host device 30 and/or a pool or spa device 50 to enable communication and/or control of the pool or spa device 50.

In one approach, the host device 30 can be, for example, another type of networkable device including one or more processors or computer devices, one or more memory devices, firmware and/or software, or any combination thereof, that is configured to communicate with the wireless access point or wireless router 40 via TCP/IP protocol.

Still referring to FIG. 1, the pool device or spa device 50 can be a pool or spa accessory device. Non-limiting examples of pool or spa accessory devices include a light, a sound system/speaker device, a deck-based or non-deck-based water flow device such as a waterfall or a fountain, a device for controlling a mechanical water treatment system, a valve, a valve actuator, and a specialty lighting device such as an underwater projection device. It should be understood that, although only one pool device or spa device 50 is shown, multiple pool devices or spa devices can be provided. Additionally, it should be understood that, although only one pool or spa 60 is shown, one or more pool and/or spa devices 50 of one or more pools, spas, and/or other water features 60 may be connected utilizing one or more installation devices 10.

Continuing with reference to FIG. 1, the installation device 10 and the client/host device 30 can have a connection 13 that may include, in one example, a Universal Serial Bus (USB) connection, including USB hardware and functionality. However, the connection 13 can also be another type of wired connection, for example but certainly not limited to an RS485 connection, or a wireless connection, for example but certainly not limited to Bluetooth, Wi-Fi, or similar wireless protocols. The host device 30 may also include Ethernet and/or Wi-Fi hardware and functionality. The host device 30 can be connected to the wireless access point or wireless router 40 by a connection 33, which may comprise an Ethernet connection or a wireless connection, and which may be effected through the LAN 20 or independent of the LAN 20.

As indicated above, the installation device 10 can be configured to connect the pool or spa device 50 through the host device 30 to the LAN 20. According to an embodiment, upon establishment of the connection 13 between the installation device 10 and the host device 30, the installation device 10 can send or “push” the configuration file 15 to the wireless access point/wireless router 40 through the host device 30 and the connections 13, 33. The configuration file 15 can include written instructions and/or data that are executable to connect the pool device or spa device 50 to the LAN 20 through the host device 30, and can be embodied in firmware, software or a combination of firmware and software. In one embodiment, the configuration file 15 includes information related to a Service Set Identifier (SSID) and password associated with a target LAN to which the pool device or spa device 50 is to connect.

Once the pool device or spa device 50 is connected to the LAN 20 through the host device 30, the pool or spa device 50 can be accessed by or can access other devices connected to the LAN 20. When the pool device or spa device 50 is connected to the host device 30, the pool device or spa device 50 can be accessed from within the LAN 20.

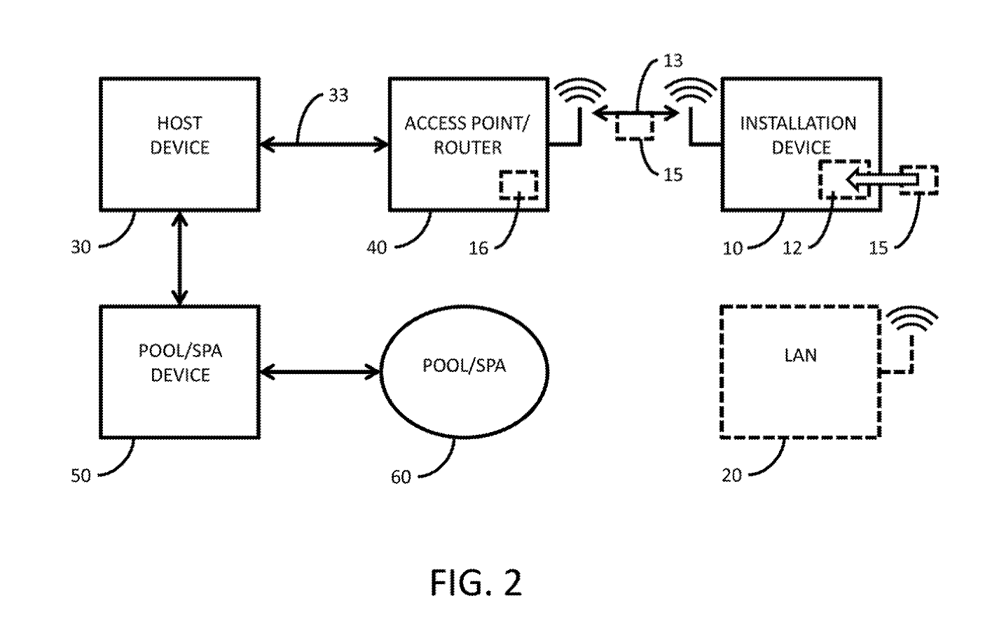

FIG. 2 illustrates another embodiment and shows an installation device 10 interfaced to the wireless access point 40 through a default SSID & Password of the wireless access point/router 40. A web browser of the installation device 10 accesses a web server 16 on the wireless access point/router 40 and the configuration file 15 can be generated by the installation device 10 and/or the router 40. A reboot command can be issued to the wireless access point/router 40 to implement the configuration. Upon power up, the wireless access point/router 40 will be able to connect to the LAN 20. The pool/spa device 50 can then connect to the LAN 20 through the host device 30 and the wireless access point/router 40.

Still referring to FIG. 2, the installation device 10 can be a handheld device, a smartphone, a tablet computer, or a computer, for example. Still referencing FIG. 2, the installation device 10 can include one or more memory devices configured to store a web browser application 12, at least one processor configured to execute the web browser application 12, a display configured to display a configuration web page generated through execution of the web browser application 12, and/or an input interface for receiving configuration information input by a user input to the web browser application 12.

The installation device 10 can be configured to access a default network setup SSID of the wireless access point/wireless router 40, and thus can be connected to the wireless access point/wireless router 40 by the connection 13, which may include a Wi-Fi connection. The web browser application 12 can be operable to display a configuration web page on a display of the installation device 10 to allow entry or selection of configuration information 15 by a user through the configuration web page. The installation device 10 can be operable to send the configuration information 15 to the wireless access point/router 40 via the connection 13 and thereby configure the wireless access point/wireless router 40 to enable the pool or spa device 50 to connect to the LAN 20. As discussed with respect to the embodiment of FIG. 1, once the pool device/spa device 50 is connected to the LAN 20, the pool/spa device 50 can be accessed by other devices connected to the LAN 20 in order to control the pool device/spa device 50.

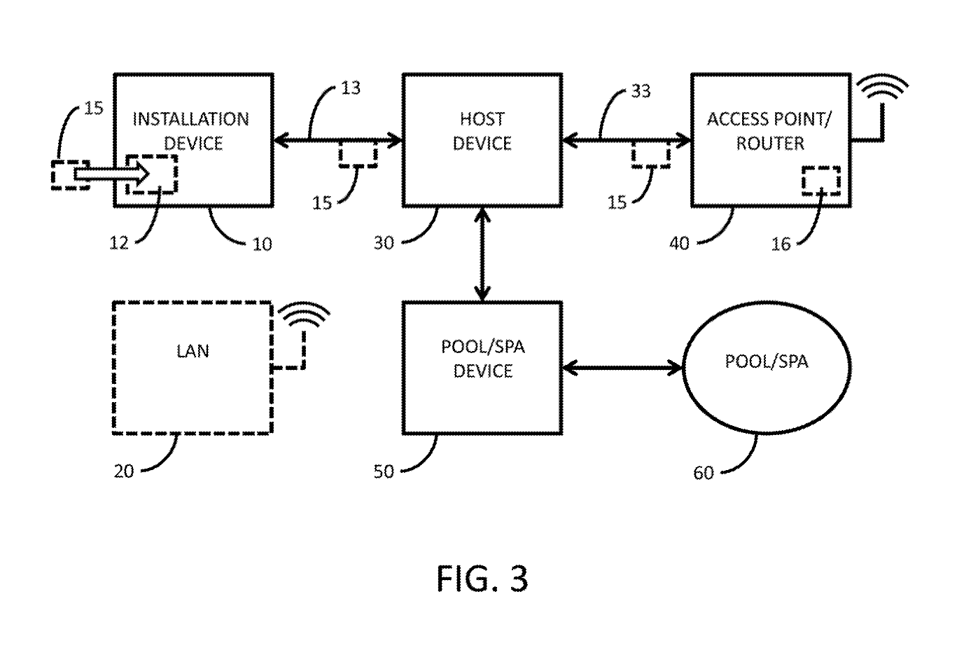

FIG. 3 shows an installation device 10 interfaced with a host device 30 for connecting a network-enabled pool device or spa device 50 to the LAN 20 through the host device 30 and the wireless access point/router 40 according to another embodiment of the invention. The installation device 10 and the host device 30 can be connected to each other by a connection 13. The connection 13 can be a USB connection or other type of wired connection, for example. Alternatively, the connection 13 can be a wireless connection such as a Bluetooth or a Wi-Fi connection, for example. Also as shown in FIG. 3, the host device 30 can be connected to the wireless access point/wireless router 40 by a connection 33, which may comprise an Ethernet or wireless connection. The connections 13 and 33 can be established between the installation device 10 and the wireless access point/wireless router 40 through the host device 30 once the installation device 10 is connected to the host device 30. After the pool device/spa device 50 is connected to the LAN 20, the pool or spa device 50 can be accessed by other devices connected to the LAN 20 in order to control the pool device/spa device 50.

While reference may be made herein to a pool device or a spa device, the terms pool device and/or spa device should be not be limited and should be interpreted to include any device related to any device containing water, for example, a pool, a spa, a waterfall, a fountain, or any other water device. It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. An installation device for connecting a pool device or spa device to a local area network, comprising:
at least one memory device configured to store a web browser application;
at least one processor configured to execute the web browser application;
a server configured to generate a configuration web page through execution of the web browser application; and
at least one input interface configured to receive user inputs including configuration information, wherein
the installation device is configured to connect to a host device that is connected to a wireless access point or wireless router in the local area network,
the installation device is configured to display the configuration web page based on the host device detecting a connection established between the installation device and the wireless access point or wireless router through the host device,
the web browser application is operable to receive the configuration information through the web page, and
the installation device is configured to send the configuration information to the wireless access point or wireless router through the host device in order to configure the wireless access point or wireless router to enable a pool device or spa device to connect to the local area network.

2. The installation device of claim 1, wherein the installation device is in the form of a flash memory derive, a smart phone, a tablet computer, or a computer.

3. The installation device of claim 1, wherein the pool or spa device is a light, a sound system, a speaker device, a deck-based water flow device, a non-deck-based water flow device, a water treatment system device, a valve, a valve actuator, or an under water projection device.

4. The installation device of claim 1, wherein the host device includes one or more processors, one or more computer device, one or more memory devices, firmware, or software.

5. The installation device of claim 1, wherein the installation device and the host device are wirelessly connected by Bluetooth or wi-fi.

6. The installation device of claim 1, wherein the installation device is configured to push the configuration file to the wireless access point or wireless router.

7. The installation device of claim 1, wherein the input interface is in the form of a keyboard or touchscreen.

8. The installation device of claim 1, further including a display configured to display the configuration web page.
